(19) United States
(12) Patent Application Publication
(10) Pub. No.: US 2008/0032647 A1
(43) Pub. Date: Feb. 7, 2008

(54) Broadcast signal interface device and method thereof

(76) Inventors: James Buchheim, Ft Lauderdale, FL (US); Arne Hennig, Ft Lauderdale, FL (US); Donald Krcmarik, Dearborn Heights, MI (US); James Rocco Tricarico II, Bethesda, MD (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/723,748

(22) Filed: Mar. 21, 2007

Related U.S. Application Data
(63) Continuation of application No. 11/499,870, filed on Aug. 7, 2006, now abandoned.
(60) Provisional application No. 60/705,497, filed on Aug. 5, 2005.

(51) Int. Cl. H04B 7/08

(52) U.S. Cl. 455/132

(57) ABSTRACT

Provided are a broadcast signal interface unit and method for converting program content and ancillary data of a first broadcast type into a broadcast channel of a second broadcast signal type. The broadcast channel of the second broadcast signal type is provided to one or more broadcast receivers of the second broadcast signal type in order to reproduce the program content and the ancillary data. The broadcast signal converter includes a converter for generating the broadcast channel of the second broadcast signal type. The generated broadcast channel of the second broadcast signal type comprises the program content and ancillary data.

### CROSS REFERENCE TO RELATED APPLICATIONS

This application claims the benefit under 35 U.S.C. §120 of U.S. patent application Ser. No. 11/499,870, filed Aug. 7, 2006, which claims the benefit under 35 U.S.C. §119(e) of U.S. Provisional Patent Application Ser. No. 60/705,497, filed Aug. 5, 2005, the entire disclosures of which are hereby incorporated by reference.

### BACKGROUND OF THE INVENTION

1. Filed of the Invention

The present invention relates to a broadcast signal interface device and a method thereof. More particularly, the present invention relates to a broadcast signal interface device and a method for converting a broadcast channel of a first broadcast signal type comprising program content and ancillary data into a broadcast channel of a second broadcast signal type in order to reproduce the program content and ancillary data on a broadcast receiver of the second broadcast signal type.

2. Background of the Invention

Broadcasting technologies are primarily used to distribute radio or television program content via a transmitted broadcast stream. Broadcasting technologies are particularly beneficial in that they transmit program content utilizing the same amount of bandwidth regardless of the number of recipients. In order to distribute the program content, broadcasting technologies utilize terrestrial and/or satellite transmissions that may be reflected, relayed, repeated or directly received. Typically, a broadcast stream includes numerous logical channels with each channel being used to distribute differing program content. Many broadcast technologies further include ancillary data in addition to the program content for each or select channels. The ancillary data can be related or unrelated to the broadcast program content. Typically, the ancillary data is reproduced separately from the program content by a broadcast receiver. Consumers have become accustomed to receiving the added value provided by the ancillary data.

As broadcasting technologies continue to evolve, the number of commercially utilized broadcast types continues to increase. Exemplary terrestrial radio services that comprise program content and ancillary data include Frequency Modulation (FM) with Radio Data System (RDS), Amplitude Modulation (AM) In-Band On-Channel (IBOC), Frequency Modulation (FM) In-Band On-Channel (IBOC), terrestrial Digital Audio Broadcast (DAB), Digital Radio Mondiale (DRM), and Integrated Services Digital Broadcasting—for Terrestrial Sound Broadcasting (ISDB-TSB). Exemplary satellite radio services that comprise program content and ancillary data include satellite DAB, Worldspace digital radio, and Satellite Digital Audio Radio Service (SDARS). Although not exemplified above, many terrestrial or satellite television broadcasting services exist that comprise program content and ancillary data.

Typically, broadcast receivers are designed to receive and reproduce signals from a specific type of broadcast. Broadcast receivers can be stationary receivers or mobile receivers (e.g., a receiver that is hand-carried by a user or is mounted in a vehicle). Further, many broadcast receivers are coupled to or mounted in other devices such that it would be difficult, inconvenient, and/or cost prohibitive to replace or modify the receiver. For example, many vehicles are provided with FM radio receivers that are integrally mounted to the vehicle.

Accordingly, consumers may find themselves in the situation where they have a receiver designed for one broadcast type but desire to utilize the receiver to reproduce program content and ancillary data from another broadcast type. The above situation is exemplified below in the context of SDARS and FM-RDS.

SDARS is a satellite broadcast service established by the U.S. Federal Communications Commission (FCC) that employs satellite transmission of digital audio programs and ancillary information to satellite radio receivers.

The broadcast stream that provides a SDARS can have on the order of hundreds of different program channels to transmit different types of music programs (i.e., jazz, classical, rock, religious, country, and so on) and talk programs (i.e., regional, national, political, financial and sports). The SDARS can also provide emergency information, travel advisory information, educational programs and the like.

A programming center is configured to broadcast program content and ancillary data that can be related or unrelated to the broadcast program content to one or more of the satellite receivers. The ancillary information comprises Program Associated Data (PAD) which can be used to identify song titles, artist's names, music genre, broadcast channel number and so on. PAD is generally synchronized with program content transmission to facilitate identification of the song title and artist of the corresponding content being played on the portable SDARS receiver or FM radio having an SDARS interface.

Many existing FM radios are configured to receive the RDS service that allows FM broadcasters to provide ancillary information that can be transmitted along with the program content for playback and display on a display device of an FM-RDS radio. FM-RDS radios are predominantly utilized in vehicles, however FM-RDS radios may also be portable or stationary. RDS-enabled radios are able to in real time receive and decode RDS information provided in the FM broadcast, such as station name, travel bulletins, name of program currently being broadcast and/or artists. The RDS display is generally characterized by eight characters to a line with a refresh rate of 0.4 to two seconds. For reasons described below, a need exists for an SDARS receiver to interface with an FM-RDS radio unit in such a way as to display SDARS information (e.g., PAD) on the display of the FM-RDS radio.

With regard to SDARS receivers for use in vehicles, XM Satellite Radio Inc. provides a number of installation options, by way of an example. In each of the following installation configurations, the SDARS receiver device provides the electronics, as well as an antenna for receiving a satellite broadcast signal comprising SDARS, for decoding and modulating SDARS for playback via an FM radio that typically is already installed in the vehicle. A plug-and-play SDARS receiver is available for use in the home, car or office which can be installed in a vehicle using a car kit that comprises a cradle or stand, a cassette tape adaptor for playback through the FM radio cassette player (if available), and vehicle power input cable, as well as an antenna for mounting on the vehicle. Besides the use of the cassette tape adaptor, many plug-and-play receivers have built-in wireless FM transmitters to transmit the SDARS program content to the FM radio as described in U.S. Pat. No. 6,493,546 which is incorporated by reference herein. Another option is to use a directly connected and hardwired receiver, such as an SDARS-ready head unit. The head unit can include an SDARS direct tuner box that connects directly to the back of an after-market FM vehicle radio to allow the head unit to control the SDARS channel selection.

Many of the head units are used in a two-part configuration that connects a smart digital adaptor to a universal tuner box. The smart digital adaptor is designed to work with a specific after-market head unit or the control system of a particular automobile. For instance, a universal tuner box can be connected to a car stereo available from Sony Corporation with a smart digital adaptor designed for Sony Corporation devices. Similarly, a BMW automobile with an in-dash Sirius satellite radio can employ a universal tuner box adapted to receive the SDARS service provided by XM Satellite Radio Inc. with a smart digital adaptor for BMW vehicles to interface the BMW stereo to an XM system.

Many vehicle owners, however, are reluctant to install an SDARS plug-and-play receiver unit or head unit in their vehicles which generally requires running various cables behind the dashboard and mounting the plug-and-play unit or universal tuner box and/or smart digital adaptor. These users have the option to use a portable SDARS receiver and player such as the portable device disclosed in U.S. patent application Ser. No. 10/831,343, filed Apr. 26, 2004 and incorporated herein by reference. However, the displays on portable players are generally small as compared to the FM radio display and inconvenient to view and obtain information about the channel, song title, and artist's name of the program content being reproduced. A need therefore exists for an interface that allows for the SDARS data to be displayed on an existing FM-RDS radio.

Development of the smart digital adaptors to interface with a specific after-market head unit or particular automobile control system has, in the past, required knowledge of the command and control bus system developed by the respective automobile manufactures and therefore raised concerns regarding potential interference with vehicle diagnostics and control of such devices as the vehicle brakes or airbags. A need therefore also exists for an SDARS receiver unit that can either be hardwired to the antenna harness as opposed to the vehicle wiring harness or bus, or wirelessly transmit to the antenna of the vehicle's radio. The above needs exemplified in the context of SDARS and FM-RDS, equally extends to other broadcast types. Accordingly, a need exists to be able to receive a first type of broadcast signal that comprises program content and ancillary data and enable a receiver operable with a second broadcast signal type to reproduce the program content and ancillary data.

### SUMMARY OF THE INVENTION

Exemplary embodiments of the present invention address at least the above problems and/or disadvantages and provide at least the advantages described below. Accordingly, an aspect of the present invention is to provide a broadcast signal interface unit to convert a broadcast channel of a first broadcast signal type comprising program content and ancillary data into a broadcast channel of a second broadcast signal type in order to reproduce the program content and ancillary data on a broadcast receiver of the second broadcast signal type.

In accordance with an aspect of the present invention, a broadcast signal interface unit is provided for converting program content and ancillary data of a first broadcast signal type into a broadcast channel of a second broadcast signal type. The broadcast channel of the second broadcast signal type is provided to one or more broadcast receivers of the second broadcast signal type in order to reproduce the program content and the ancillary data. The broadcast signal converter preferably comprises a converter for generating the broadcast channel of the second broadcast signal type, wherein the generated broadcast channel of the second broadcast signal type comprises the program content and the ancillary data of the first broadcast signal type.

According to another aspect of the present invention, the converter reformats the ancillary data prior to generating the broadcast channel of the second broadcast signal type, wherein the ancillary data is formatted according to an ancillary data format of the second broadcast signal type.

According to a further aspect of the present invention, the converter, when reformatting the ancillary data, segments the ancillary data such that individual segments are individually and consecutively reproduced by the one or more broadcast receivers of the second broadcast signal type.

According to yet another aspect of the present invention, the converter, when reformatting the ancillary data, adds, subtracts or substitutes data from the converter or a broadcast receiver of the first broadcast signal type.

According to still another aspect of the present invention, the converter generates the broadcast channel of the second broadcast signal type by directly converting a broadcast channel of the first broadcast signal type into the broadcast channel of the second broadcast signal type.

According to yet a further aspect of the present invention, the converter generates the broadcast channel of the second broadcast signal type from the program content and the ancillary data of the broadcast channel of the first broadcast signal type.

According to another aspect of the present invention, the converter is provided with the ancillary data of the broadcast channel of the first broadcast signal type from a receiver of the first broadcast signal type.

According to a further aspect of the present invention, the receiver of the first broadcast signal type is coupled to the broadcast signal converter via a wired connection.

According to yet another aspect of the present invention, the broadcast signal interface unit further comprises the receiver of the first broadcast signal type.

According to still another aspect of the present invention, the broadcast signal interface unit is portable.

According to yet a further aspect of the present invention, the first broadcast signal type is a Satellite Digital Audio Radio Service (SDARS).

According to another aspect of the present invention, the ancillary data is Program Associated Data (PAD).

According to a further aspect of the present invention, the second broadcast signal type is Frequency Modulation (FM) with Radio Data Service (RDS).

According to yet another aspect of the present invention, the broadcast channel of the second broadcast signal type is provided either wirelessly or via a wired connection to the one or more broadcast receivers of the second broadcast signal type.

According to a further aspect of the present invention, the program content and ancillary data of the first broadcast signal type are program content and ancillary data from a currently or newly selected channel of the first broadcast signal type, wherein the ancillary data is associated with the program content.

According to yet another aspect of the present invention, the program content and ancillary data of the first broadcast signal type are program content from a currently or newly selected channel of the first broadcast signal type and the and ancillary data from a currently or newly browsed channel of the first broadcast signal type, wherein the ancillary data is not associated with the program content.

According to still another aspect of the present invention, the converter comprises a controller for sending one or more commands to a receiver of the first broadcast signal type. The one or more commands comprises a request for ancillary data of the last received broadcast channel or a user command to change the current broadcast channel received by the receiver of the first broadcast signal type.

According to yet a further aspect of the present invention, the one or more broadcast receivers reproduce the program content and the ancillary data separately.

In accordance with an aspect of the present invention, a method of converting program content and ancillary data of a first broadcast signal type into a broadcast channel of a second broadcast signal type is provided. The broadcast channel of the second broadcast signal type is provided to one or more broadcast receivers of the second broadcast signal type in order to reproduce the program content and the ancillary data. The method comprises the steps of generating the broadcast channel of the second broadcast signal type, wherein the generated broadcast channel of the second broadcast signal type comprises the program content and ancillary data of the first broadcast signal type.

According to another aspect of the present invention, the method comprises the step of reformatting the ancillary data according to an ancillary data format of the second broadcast signal type.

According to a further aspect of the present invention, the step of reformatting the ancillary data comprises the step of segmenting the ancillary data such that individual segments are individually and consecutively reproduced by the one or more broadcast receivers of the second broadcast signal type.

According to yet another aspect of the present invention, the step of reformatting the ancillary data comprises the step of adding, subtracting or substituting data from the ancillary data.

According to still another aspect of the present invention, the step of generating the broadcast channel of the second broadcast signal type comprises the step of directly converting a broadcast channel of the first broadcast signal type into the broadcast channel of the second broadcast signal type.

According to yet a further aspect of the present invention, the step of generating the broadcast channel of the second broadcast signal type comprises the step of converting the program content and the ancillary data of the broadcast channel of the first broadcast signal type into the broadcast channel of the second broadcast signal type.

According to another aspect of the present invention, the step of generating the broadcast channel of the second broadcast signal type is performed by a converter. The ancillary data of the broadcast channel of the first broadcast signal type is provided from a receiver of the first broadcast signal type to the converter.

According to a further aspect of the present invention, the ancillary data of the broadcast channel of the first broadcast signal type is provided from the receiver of the first broadcast signal type to the converter via a wired connection.

According to yet another aspect of the present invention, the receiver of the first broadcast signal type and the converter are integrally provided within a common housing.

According to still another aspect of the present invention, the receiver of the first broadcast signal type and the converter are integrally provided within a portable device.

According to yet a further aspect of the present invention, the first broadcast signal type is a Satellite Digital Audio Radio Service (SDARS).

According to another aspect of the present invention, the ancillary data is Program Associated Data (PAD).

According to a further aspect of the present invention, the second broadcast signal type is Frequency Modulation (FM) with Radio Data Service (RDS).

According to yet another aspect of the present invention, the step of providing the broadcast channel of the second broadcast signal type either wirelessly or via a wired connection to the one or more broadcast receivers of the second broadcast signal type.

According to a further aspect of the present invention, the program content and ancillary data of the first broadcast signal type are program content and ancillary data from a currently or newly selected channel of the first broadcast signal type, wherein the ancillary data is associated with the program content.

According to yet another aspect of the present invention, the program content and ancillary data of the first broadcast signal type are program content from a currently or newly selected channel of the first broadcast signal type and the and ancillary data from a currently or newly browsed channel of the first broadcast signal type, wherein the ancillary data is not associated with the program content.

According to still another aspect of the present invention, the step of sending one or more commands to a receiver of the first broadcast signal type, wherein the one or more commands comprises a request for ancillary data of the last received broadcast channel or a user command to change the current broadcast channel received by the receiver of the first broadcast signal type.

According to yet a further aspect of the present invention, the one or more broadcast receivers reproduce the program content and the ancillary data separately.

In accordance with an aspect of the present invention, a computer-readable medium having embodied thereon a computer program for the method of converting program content and ancillary data of a first broadcast signal type into a broadcast channel of a second broadcast signal type is provided. The broadcast channel of the second broadcast signal type is provided to one or more broadcast receivers of the second broadcast signal type in order to reproduce the program content and the ancillary data. The method comprises generating the broadcast channel of the second broadcast signal type, wherein the generated broadcast channel of the second broadcast signal type comprises the program content and ancillary data of the first broadcast signal type.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is an overall block diagram for illustrating an SDARS receiver unit and an RDS-enabled FM radio in accordance with an exemplary embodiment of the present invention;

FIG. 2A is a block diagram of an FM-RDS interface unit in accordance with an exemplary embodiment of the present invention;

FIG. 2B is a block diagram of an FM-RDS interface unit in accordance with another exemplary embodiment of the present invention;

FIG. 2C is a block diagram of an FM-RDS interface unit in accordance with yet another exemplary embodiment of the present invention;

FIG. 3A is a block diagram of the a SDARS universal tuner interface in accordance with an exemplary embodiment of the present invention;

FIG. 3B is a block diagram of the a SDARS universal tuner interface in accordance with another exemplary embodiment of the present invention;

FIG. 3C is a block diagram of the a SDARS universal tuner interface in accordance with still another exemplary embodiment of the present invention;

FIG. 3D is a block diagram of the a SDARS universal tuner interface in accordance with yet another exemplary embodiment of the present invention;

FIG. 4 is an illustration of a display of an FM-RDS radio displaying SDARS data in an RDS format, in accordance with an exemplary embodiment of the present invention; and

FIG. 5 is flowchart illustrating operations for converting SDARS program content and ancillary data for output in an RDS format on an FM-RDS radio, in accordance with an exemplary embodiment of the present invention.

Throughout the drawings, the same drawing reference numerals will be understood to refer to the same elements, features, and structures.

### DETAILED DESCRIPTION OF EXEMPLARY EMBODIMENTS *

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness.

Although exemplary embodiments of the present invention will be described below in the context of the SDARS and FM-RDS broadcast types, exemplary embodiments of the present invention are equally applicable to any two differing broadcast types that are capable of comprising program content and ancillary data.

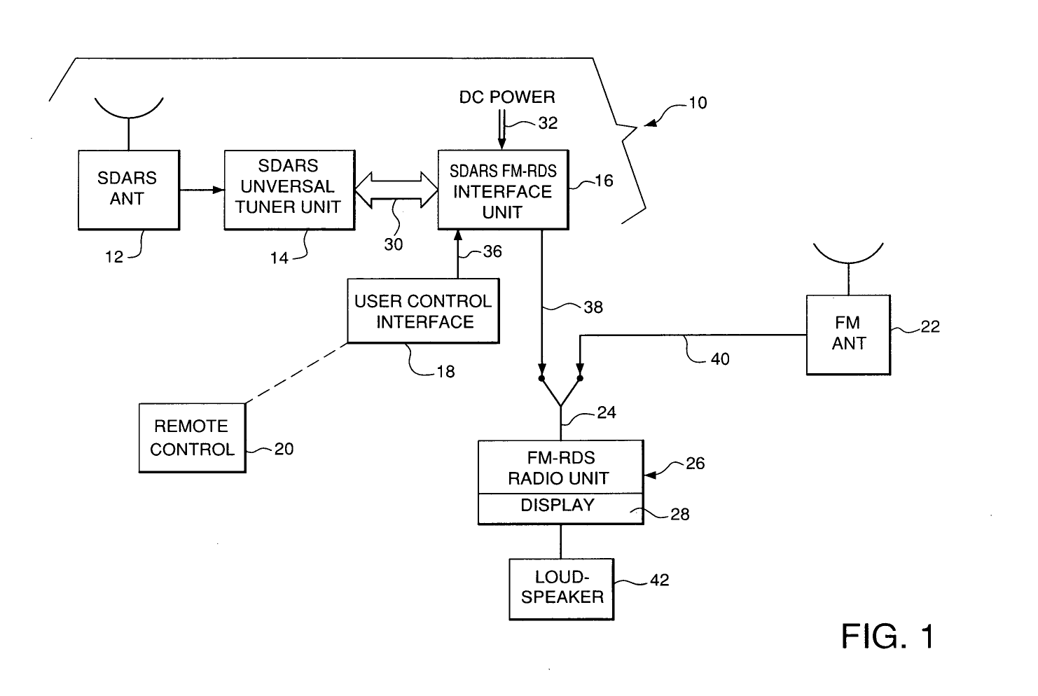

FIG. 1 is a diagram illustrating an SDARS receiving unit with FM-RDS capability and an FM-RDS radio in accordance with an exemplary embodiment of the present invention. The SDARS receiver unit with FM-RDS capability 10 comprises an SDARS universal tuner unit 14 for receiving and decoding an SDARS broadcast stream received via an SDARS antenna 12. The SDARS universal tuner unit 14 has a wired connection 30, such as an 8-pin Mini Din, connected to an SDARS FM-RDS interface unit 16. The wired connection 30 is used to provide the SDARS program content and SDARS ancillary data to the SDARS FM-RDS interface unit 16. Further, wired connection 30 is used to send commands and messages from the SDARS FM-RDS interface unit 16 to the SDARS universal tuner unit 14. Preferably, the SDARS program content and SDARS ancillary data are sent from the SDARS universal tuner unit 14 in a single encrypted digital signal. However, the SDARS program content and SDARS ancillary data may also be sent from the SDARS universal tuner unit 14 as an analog or digital audio signal comprising the SDARS program content and a digital signal comprising the SDARS ancillary data. Alternatively, the SDARS universal tuner unit 14 may provide the entire received broadcast stream or the received broadcast stream for a selected channel without being decoded by SDARS universal tuner unit 14. The SDARS FM-RDS interface unit 16 preferably receives power from the vehicle battery, as indicated at 32, and can provide power to the SDARS universal tuner unit 14 via wired connection 30. The SDARS FM-RDS interface unit 16 may be coupled to a user control interface 18 via cable 36. Further, the SDARS FM-RDS interface unit 16 outputs an FM-RDS broadcast signal via output cable 38 to an FM-RDS radio unit 26. Output cable 38 may be connected to one leg of a Y-splitter 24 which is in turn connected to the FM-RDS radio unit 26. During installation, the cable 40 connecting the FM antenna 22 to the FM radio 26 can be disconnected from the FM-RDS radio unit 26 or remote tuner and connected to the other leg of the Y-splitter 24. In this way, both the output from the SDARS FM-RDS interface unit 16 and the full FM broadcast spectrum received via FM antenna 22 are received at the existing FM-RDS radio 26. Alternatively, the SDARS FM-RDS interface unit 16 outputs an FM-RDS broadcast signal wirelessly to the FM radio 26.

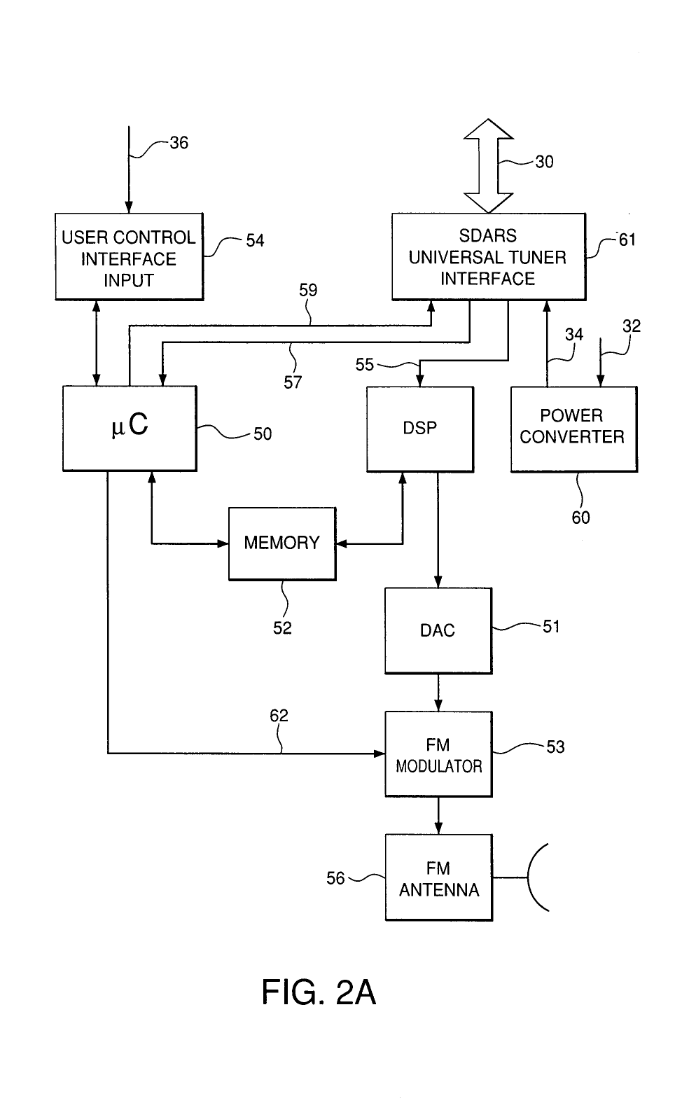

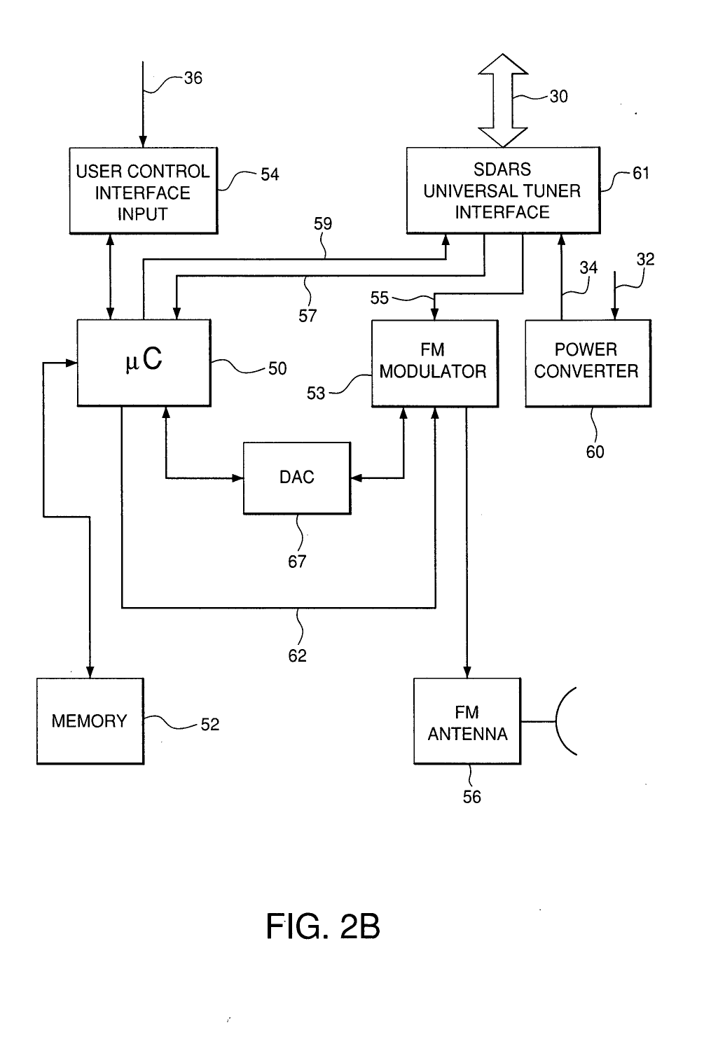

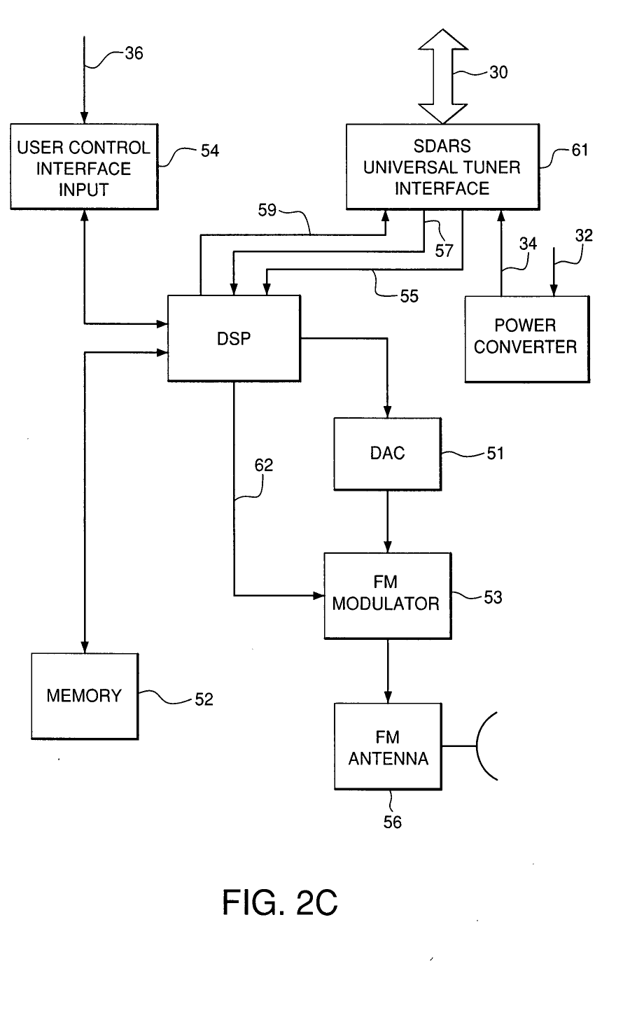

With reference to FIG. 2A, the SDARS FM-RDS interface unit 16 comprises a microcontroller 50, a digital to analog converter (DAC) 51, memory device 52, an FM modulator 53, a user control interface receiver 54, a transmit antenna 56, digital signal processor (DSP) 58, a power converter 60 and SDARS universal tuner interface 61. The SDARS FM-RDS interface unit 16 is preferably coupled to a user control interface 18 (FIG. 1). User control interface 18 is preferably a wireless receiver for use with a wireless remote control 20 (FIG. 1). Preferably, user control interface 18 and remote control 20 communicate via infrared (IR), but alternately may communicate by radio frequency (RF) or by an inductive or capacitive coupling, or any other suitable method. When user control interface 18 and remote control 20 communicate via IR, user control interface 18 includes an IR sensor and remote control 20 includes an IR transmitter (not shown). Further, when user control interface 18 and remote control 20 communicate via IR, user control interface 18 may be mounted to receive line of sight IR transmissions from remote control 20. For example, user control interface 18 could be mounted on a dashboard of a vehicle (i.e., in the air vent) such that a user can press channel selection buttons on remote control 20 which generates infrared output signals that are received by the user control interface 18 and processed at the user control interface input 54. However, if user control interface 18 and remote control 20 communicate via RF or by an inductive or capacitive coupling, user control interface 18 could be mounted out of sight or may be included with the SDARS FM-RDS interface unit 16. Further, when user control interface 18 and remote control 20 communicate via RF, they may communicate using a Bluetooth or WiFi communication. Remote control 20 could be a dedicated remote, cellular phone, wristwatch, PDA, portable computer, or the like. Alternatively, instead of user control interface 18 and remote control 20, a wired control unit (not shown) may be used. In addition, user control interface input 54 may be omitted. Further, user control interface 18 may be included with the SDARS FM-RDS interface unit 16. Still further, the SDARS FM-RDS interface unit 16 may include manual controls.

The microcontroller 50 may be programmed to communicate with the SDARS universal tuner unit 14 according to the SDARS communication bus and messaging system. For example, communications from the SDARS universal tuner unit 14 to microcontroller 50 include SDARS ancillary data and tuner data. The SDARS ancillary data may be updated SDARS ancillary data for a currently selected or currently browsed channel or SDARS ancillary data for a newly selected or browsed channel. The currently selected channel is the channel of the SDARS broadcast stream for which SDARS program content is being sent from the SDARS universal tuner unit 14 to the SDARS FM-RDS interface unit 16. A currently browsed channel is a channel of the SDARS broadcast stream other than the currently selected channel for which SDARS ancillary data is being sent from the SDARS universal tuner unit 14 to the SDARS FM-RDS interface unit. Tuner data is data used to convey information related to the operation of the tuner. For example, tuner data may include an indication of received signal strength or an identification of a channel as a user programmed recall channel. Preferably, SDARS ancillary data is PAD, but the SDARS ancillary data may be other data sent via an SDARS broadcast. By way of example, communications from the microcontroller 50 to the SDARS universal tuner unit 14 includes commands and messages. Preferably the commands and messages are used to control, provide information to, or request information from the SDARS universal tuner unit 14. For example, when the microcontroller 50 receives user commands via user control interface 18 to change the current selected or browsed channel, microcontroller 50 sends a corresponding command to the SDARS universal tuner unit 14. Any of the above communications may be sent once, continuously, and/or be repeated at a certain interval. Further, any of the above communications may be sent upon request, automatically, at certain times, at certain intervals, and/or when certain conditions are met.

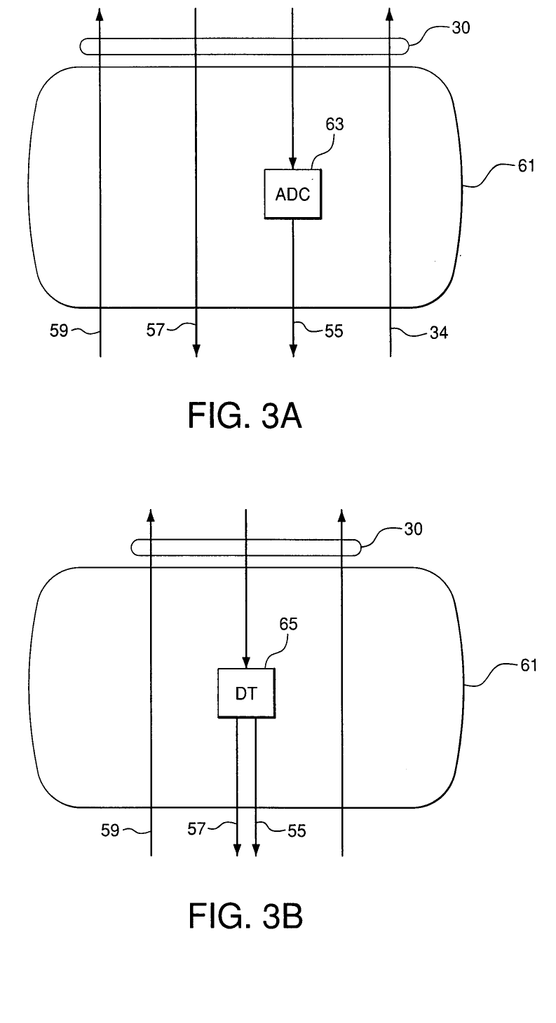

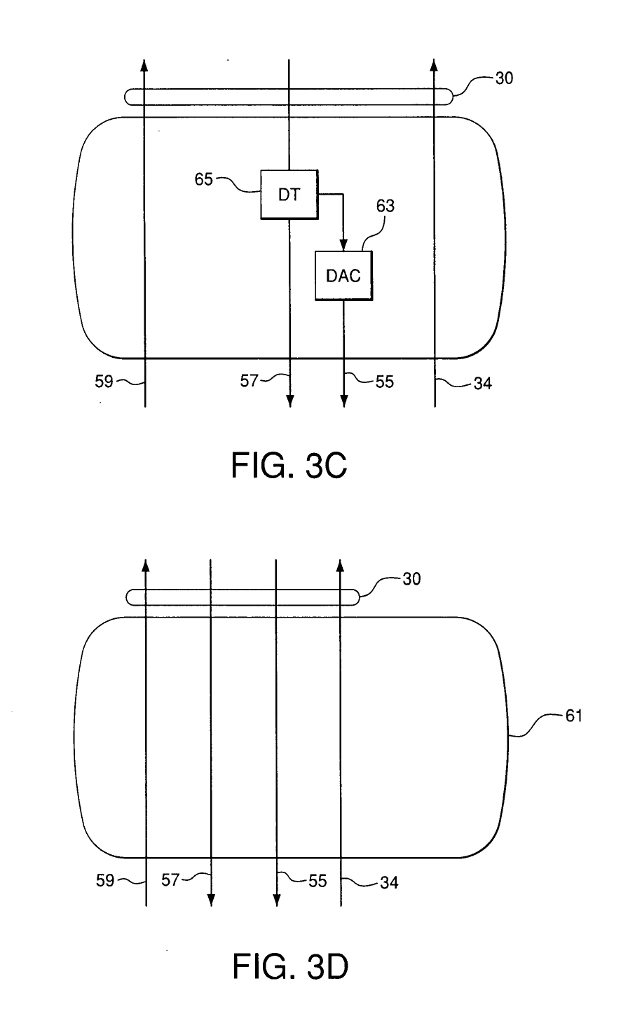

The SDARS universal tuner interface 61 interfaces the microcontroller 50 and DSP 58 with the SDARS Universal Tuner 14. The SDARS universal tuner interface 61 receives communications from the SDARS Universal Tuner 14 via wired connection 30 and communicates received program content to DSP 58 via path 55 and received communications for microcontroller 50 via path 57. Further, the SDARS universal tuner interface 61 receives communications from microcontroller 50 via path 59 and passes the communications to the SDARS Universal Tuner 14 via wired connection 30. The SDARS universal tuner interface 61 will be discussed in further detail below with respect to FIGS. 3A-3D.

With continued reference to FIG. 2A, when SDARS ancillary data has changed, microcontroller 50 is programmed to convert the SDARS ancillary data (e.g., PAD) into RDS formatted data and to provide the RDS formatted data to DSP 58. The RDS formatted data may be provided to DSP 58 via memory 52. Alternatively, microcontroller 50 can provide the RDS formatted data directly to DSP 58. In a further alternative, DSP 58 may perform the RDS formatting by receiving the SDARS ancillary data directly or via microcontroller 50. When generating the RDS formatted data, the tuner data or data related to the operation of the SDARS FM-RDS interface unit 16 may be added to or substituted for the SDARS ancillary data in the RDS formatted data. The data related to the operation of the SDARS FM-RDS interface may be generated by microcontroller 50 or DSP 58. Further, when generating the RDS formatted data, the converting may include truncating or segmenting the inputted data such that the inputted data occupies more than one line of RDS data with lines being consecutively included in the FM-RDS broadcast signal continuously or at a set rate. Still further, the line or lines of RDS formatted data may be repeated if no new input data is provided.

DSP 58 receives the SDARS program content of the currently received channel as a digital audio signal from the SDARS universal tuner interface 61 and the RDS formatted data as a digital signal from the microcontroller 50. DSP 58 is programmed to generate the signal that is used to produce the FM-RDS broadcast signal from the received program content and RDS formatted data. The generated signal is output to DAC 51 and is then sent to FM modulator 53 to produce the FM-RDS broadcast signal on a selected channel. The FM modulator 53 is controlled by microcontroller 50 via path 62 to among other things produce the FM-RDS broadcast signal on the selected channel. Alternatively, DSP 58 may control the FM modulator 53. Preferably, the selected channel for the FM-RDS broadcast signal is chosen as described in U.S. Pat. No. 6,493,546. However, the selected channel may be chosen in any other manner.

The FM modulator 53 outputs the selected channel of the FM-RDS broadcast signal to the FM transmit antenna 56 which may be used to transmit the FM-RDS broadcast signal wirelessly or by cable 38 to at least one FM-RDS radio 26. Alternatively, the functions of DAC 51 and FM modulator 53 may be performed by DSP 58. Still further, DSP 58 may directly convert a received SDARS broadcast stream or undecoded selected SDARS channel into a selected channel of an FM-RDS broadcast signal that comprises the program content and RDS data respectively. Additionally, DSP 58 may perform the reformatting of the SDARS ancillary data into the RDS formatted data.

The power converter 60 receives power from a power source 32, such as the electrical power system of a vehicle, and provides power to the SDARS FM-RDS interface unit 16. The power converter 60 may further provide power 34 to the SDARS universal tuner unit 14 via wired connection 30 as discussed above. The functions and/or structure of any part of the microcontroller 50, DAC 51, FM modulator 53, memory 52, user control interface input 54, DSP 58, FM transmitter 56, power converter 60 and SDARS universal tuner interface 61 may be combined or separated.

With reference to FIG. 2B, the SDARS FM-RDS interface unit 16 in accordance with another exemplary embodiment of the present invention comprises a microcontroller 50, a digital to analog converter (DAC) 67, memory device 52, an FM modulator 53, a user control interface receiver 54, a transmit antenna 56, a power converter 60 and SDARS universal tuner interface 61. This embodiment is similar to the first embodiment discussed above with respect to FIG. 2A except for DSP 58 and DAC 51 being omitted, DAC 67 being added, and signal path 55 comprising an analog signal. Accordingly, discussions of similar components or functions will be omitted for the sake of clarity and conciseness. With reference to FIG. 2B, SDARS universal tuner interface 61 sends SDARS program content as an analog signal via path 55 to FM modulator 53. Further, microcontroller 50 sends the RDS formatted data as digital noise to DAC 67 which in turn outputs an analog signal to the FM modulator 53. FM modulator 53 outputs the selected channel of the FM-RDS broadcast signal to the FM transmit antenna 56. The functions and/or structure of any part of the microcontroller 50, a digital to analog converter (DAC) 67, memory device 52, an FM modulator 53, a user control interface receiver 54, a transmit antenna 56, a power converter 60 and SDARS universal tuner interface 61 may be combined or separated.

With reference to FIG. 2C, the SDARS FM-RDS interface unit 16 in accordance with another exemplary embodiment of the present invention comprises a DAC 51, memory device 52, an FM modulator 53, a user control interface receiver 54, a transmit antenna 56, a power converter 60 and SDARS universal tuner interface 61. This embodiment is similar to the first embodiment discussed above with respect to FIG. 2A except for microcontroller 50 being omitted. Further, this embodiment is similar to the first embodiment discussed above with respect to FIG. 2A except for all of signal paths from the SDARS universal tuner interface 61, user control interface receiver 54, memory 52, and FM modulator 53 that were coupled with microcontroller 50 are now coupled with DSP 58. Accordingly, discussions of similar components or functions will be omitted for the sake of clarity and conciseness. With reference to FIG. 2C, SDARS universal tuner interface 61 communicates SDARS ancillary data, tuner data and messages to DSP 58 via path 57. Further, Universal Tuner Interface 61 receives commands and/or messages from DSP 58 via path 59. Still further DSP 58 is connected to memory 52 and user control interface input 54. Additionally, FM modulator 53 is controlled to DSP 58 via path 62 to among other things produce the FM-RDS broadcast signal on the selected channel. Here, DSP 58 performs the functions disclosed above with respect to FIG. 2A of the microcontroller 50 and DSP 58. The functions and/or structure of any of part the digital to analog converter (DAC) 51, memory device 52, an FM modulator 53, a user control interface receiver 54, a transmit antenna 56, a power converter 60 and SDARS universal tuner interface 61 may be combined or separated.

In accordance with another embodiment of the present invention, an SDARS receiver unit with FM-RDS capability can be integrally provided to include both the SDARS universal tuner unit 14 and SDARS FM-RDS interface unit 16. Accordingly, the integral SDARS receiver with RDS capability can have connections to an SDARS antenna and to the FM antenna input of the existing FM-RDS radio, as well as exist outside the dashboard or remote location. The circuitry of FIGS. 2A-2C, or a hardware and software configuration adapted to perform essentially the same operations as the SDARS FM-RDS interface unit 16 in FIGS. 2A-2C, can be incorporated with the components of an SDARS universal tuner unit 14 (e.g., a portable device, a plug and play unit, among other devices).

Differing embodiments of the SDARS universal tuner interface 61 are described below with respect to FIGS. 3A-3D. The SDARS universal tuner interface 61 utilized corresponds with a type of SDARS Universal Tuner 14 and the embodiment of the SDARS FM-RDS interface unit 16 employed. In a first type of SDARS Universal Tuner 14, communications sent from the SDARS Universal Tuner 14 via wired connection 30 to the SDARS FM-RDS interface unit 16 includes the SDARS program content in analog form and the SDARS ancillary data and tuner data in digital form. In a second type SDARS Universal Tuner 14, communications sent from the SDARS Universal Tuner 14 to the SDARS FM-RDS interface unit 16 via wired connection 30 includes an encoded digital signal that includes the SDARS program content, SDARS ancillary data and tuner data. For both the first type and second type of SDARS Universal Tuner 14, commands and messages are sent in digital form from the SDARS FM-RDS interface unit 16 via wired connection 30 to the SDARS Universal Tuner 14 are in digital form. Further, for the first type and second type of SDARS Universal Tuner 14, power may be transferred via connection 30 between SDARS Universal Tuner 14 and the SDARS FM-RDS interface unit 16. Still further, SDARS Universal Tuner 14 may include provisions to operate according to both or either of the first type and second type. The embodiments of the SDARS FM-RDS interface unit 16 discussed above with respect to FIGS. 2A-2C differ by whether the SDARS program content is expected in digital or analog form. The embodiments discussed with respect to FIGS. 2A and 2C expect the SDARS program content to be in digital for whereas the embodiment discussed with respect to FIGS. 2B expects the SDARS program content to be in analog form. For all of the embodiments of the SDARS FM-RDS interface unit 16, other communications between SDARS Universal Tuner 14 and SDARS FM-RDS interface unit 16 are in digital form. Further, each of the embodiments of the SDARS FM-RDS interface unit 16 may include more than one SDARS universal tuner interface 61 that enables the SDARS FM-RDS interface unit 16 to selectively operate with either or both the first or second type of SDARS Universal Tuner 14. The embodiments of the SDARS universal tuner interface 61 will be described in greater detail below.

With reference to FIG. 3A, the SDARS universal tuner interface 61 in accordance with an exemplary embodiment of the present invention receives SDARS program content via an analog signal via wired connection 30 and passes it to an analog to digital converter (ADC) 63. ADC 63 outputs the received SDARS program content in digital form via path 55. SDARS universal tuner interface 61 receives SDARS ancillary data, tuner data and messages from the SDARS Universal Tuner 14 in digital form and passes it via path 57. SDARS universal tuner interface 61 receives commands and/or messages via path 59 and passes it to SDARS Universal Tuner 14 via wired connection 30. Preferably, the SDARS universal tuner interface 61 according to this embodiment is used with the first type of SDARS Universal Tuner 14 and the embodiments of the SDARS FM-RDS interface unit expecting the SDARS program content to be in digital form.

With reference to FIG. 3B, the SDARS universal tuner interface 61 in accordance with another exemplary embodiment of the present invention receives SDARS program data, SDARS ancillary data, tuner data and messages via wired connection 30 from the SDARS Universal Tuner 14 in encoded and/or encrypted digital form and passes it to a digital transceiver chip (DT) 65. DT 65 decodes and/or decrypts the received digital signal and outputs the SDARS program data in digital form via path 55 and outputs the SDARS ancillary data, tuner data and messages in digital form via path 55. SDARS universal tuner interface 61 receives commands and/or messages via path 59 and passes it to SDARS Universal Tuner 14 via wired connection 30. Preferably, the SDARS universal tuner interface 61 according to this embodiment is used with the second type of SDARS Universal Tuner 14 and the embodiments of the SDARS FM-RDS interface unit expecting the SDARS program content to be in digital form.

With reference to FIG. 3C, the SDARS universal tuner interface 61 in accordance with yet another exemplary embodiment of the present invention receives SDARS program data, SDARS ancillary data, tuner data and messages via wired connection 30 from the SDARS Universal Tuner 14 in encoded and/or encrypted digital form and passes it to a digital transceiver chip (DT) 65. DT 65 decodes and/or decrypts the received digital signal and outputs the SDARS program data in digital form to DAC 63 and outputs the SDARS ancillary data, tuner data and messages in digital form via path 55. DAC 63 converts the SDARS program data in digital form into SDARS program data in analog form and outputs it via path 55. SDARS universal tuner interface 61 receives commands and/or messages via path 59 and passes it to SDARS Universal Tuner 14 via wired connection 30. Preferably, the SDARS universal tuner interface 61 according to this embodiment is used with the second type of SDARS Universal Tuner 14 and the embodiments of the SDARS FM-RDS interface unit expecting the SDARS program content to be in analog form.

With reference to FIG. 3D, the SDARS universal tuner interface 61 in accordance with still another exemplary embodiment of the present invention receives SDARS program content via an analog signal via wired connection 30 and passes via path 55. SDARS universal tuner interface 61 receives via wired connection 30 SDARS ancillary data, tuner data and messages from the SDARS Universal Tuner 14 in digital form and passes it via path 57. SDARS universal tuner interface 61 receives commands and/or messages via path 59 and passes it to SDARS Universal Tuner 14 via wired connection 30. Preferably, the SDARS universal tuner interface 61 according to this embodiment is used with the first type of SDARS Universal Tuner 14 and the embodiments of the SDARS FM-RDS interface unit expecting the SDARS program content to be in analog form.

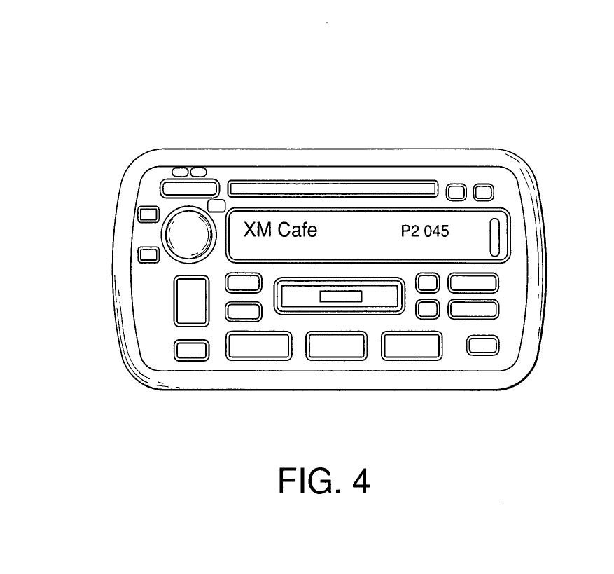

In an illustrated example, an SDRS FM-RDS interface unit 16 requests and receives from an SDARS universal tuner unit 14 the SDARS channel currently selected or currently being browsed (e.g., XM Cafe channel 45). This information is provided in SDARS ancillary data which is converted into an RDS formatted data and provided to the FM-RDS radio 26 for display on a display screen 28, as illustrated in FIG. 4. The display on an FM-RDS radio 26 is preferably refreshed every two seconds. By way of example, the display may indicate the current channel (e.g., XM Cafe channel 45), and then the artist of the currently played song, followed by the display of the song title.

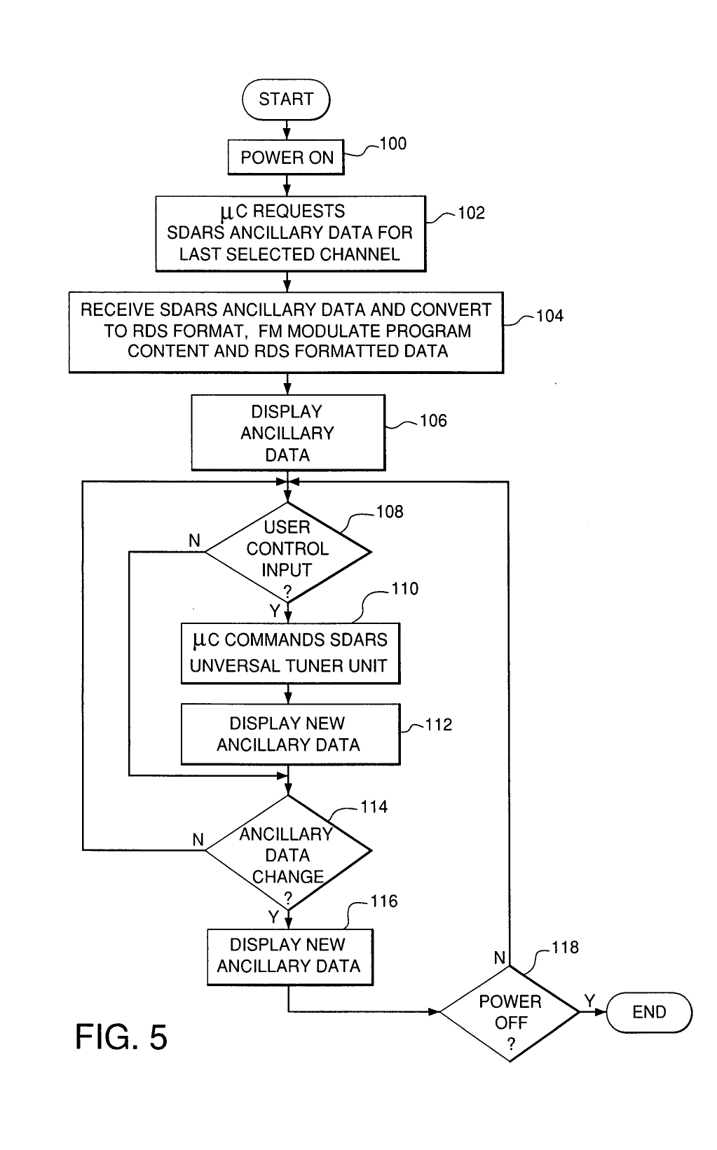

With reference to FIG. 5, the flowchart illustrates an exemplary sequence of operations performed by SDARS receiver unit with FM-RDS capability 10 in accordance with the embodiment of the SDARS FM-RDS interface unit 16 described in FIG. 2A. As indicated in step 100, the SDARS FM-RDS interface unit 16 and SDARS universal tuner unit 14 are powered on. The powering on may occur as a result of the ignition of a vehicle being powered. As indicated in step 102, the microcontroller 50 requests and receives SDARS ancillary data relating to the last channel selected and/or listened to before being powered off. The microcontroller 50 receives the corresponding SDARS ancillary data for the requested information and converts it into RDS formatted data and sends it to the DSP 58 for FM modulation by FM modulator 53 (step 104). The resulting FM-RDS broadcast signal of a certain channel is sent to and received by the FM-RDS radio 26 for display in step 106. The microcontroller 50 then looks for a user control input to determine if a user has made a currently selected or browsed channel change selection (step 108). If the user has not made a change selection in step 108 operation proceeds to step 114 discussed below. In step 110, if the user has made a new channel change selection, the SDARS ancillary data such as PAD corresponding to the new currently selected or browsed channel information is obtained from the SDARS universal tuner unit 14 and converted into RDS format. In step 112, the ancillary data is displayed in RDS format on the display 28 of the FM-RDS radio and operation proceeds to step 114. In step 114, the microcontroller 50 determines whether the currently selected or browsed SDARS channel has had a change in SDARS ancillary data received from the SDARS universal tuner unit 14. If so, as indicated in step 116, the microcontroller 50 converts the SDARS ancillary data into RDS formatted ancillary data for display on the display 28 of the FM-RDS radio. If the ancillary data had been segmented as described above, the segmented RDS formatted data is cycled on the display. For example, artist data in the ancillary data is converted into RDS format and displayed via the FM-RDS radio display device for two seconds, and then by a similar operation, the name of the currently played song is displayed for two seconds. Then the current channel information may be displayed. In step 118 it is determined if power is no longer being provided operation proceeds to step 108.

In an exemplary embodiment of the present invention, an SDARS receiver unit with FM-RDS capability 10 is provided as an outboard solution for installation in a vehicle such that the SDARS universal tuner unit 14 and external SDARS FM-RDS interface unit 16 are connected together, and the SDARS FM-RDS interface unit 16 connects to an FM-RDS radio 26 via an antenna harness either behind the dashboard of the vehicle or in a remote location (i.e., trunk), depending on the vehicle system design.

In another exemplary embodiment of the present invention, an integral SDARS receiver unit with FM-RDS capability 10 is provided as an inboard installation solution. Accordingly, the integral SDARS receiver unit with FM-RDS capability 10 can have connections to a vehicle-mounted SDARS antenna and to the FM antenna input of the existing FM-RDS radio 26, as well as exist outside the dashboard or remote location.

In yet another exemplary embodiment of the present invention, PAD from an SDARS stream is received via an SDARS vehicle-mounted antenna and converted into an RDS format and then modulated onto an FM signal embedded in an FM broadcast stream for playback via the FM radio in the vehicle.

In still another exemplary embodiment of the present invention, embodiments of the present invention the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

Despite descriptions of the exemplary embodiments of the present invention being described above using the SDARS and FM-RDS broadcast types, the present invention is equally applicable to any two differing broadcast types that are capable of comprising program content and ancillary data.

While the invention has been shown and described with reference to certain embodiments thereof, it will be understood by those skilled in the art that various changes in form and details may be made therein without departing from the spirit and scope of the invention as defined by the appended claims and their equivalents.

1. A broadcast signal interface unit for converting program content and ancillary data of a first broadcast signal type into a broadcast channel of a second broadcast signal type, wherein the broadcast channel of the second broadcast signal type is provided to one or more broadcast receivers of the second broadcast signal type in order to reproduce the program content and the ancillary data of the first broadcast signal type, the broadcast signal interface unit comprising:
a converter for generating the broadcast channel of the second broadcast signal type, wherein the generated broadcast channel of the second broadcast signal type comprises the program content and the ancillary data of the first broadcast signal type.

2. The broadcast signal interface unit of claim 1, wherein the converter reformats the ancillary data prior to generating the broadcast channel of the second broadcast signal type, wherein the ancillary data is formatted according to an ancillary data format of the second broadcast signal type.

3. The broadcast signal interface unit of claim 2, wherein the converter, when reformatting the ancillary data, segments the ancillary data such that individual segments are individually and consecutively reproduced by the one or more broadcast receivers of the second broadcast signal type.

4. The broadcast signal interface unit of claim 2, wherein the converter, when reformatting the ancillary data, adds, subtracts or substitutes the ancillary data with data from the converter or a broadcast receiver of the first broadcast signal type.

5. The broadcast signal interface unit of claim 1, wherein the converter generates the broadcast channel of the second broadcast signal type by directly converting a broadcast channel of the first broadcast signal type into the broadcast channel of the second broadcast signal type.

6. The broadcast signal interface unit of claim 1, wherein the converter generates the broadcast channel of the second broadcast signal type from the program content and the ancillary data of the first broadcast signal type.

7. The broadcast signal interface unit of claim 6, wherein the converter is provided with the ancillary data of the first broadcast signal type from a receiver of the first broadcast signal type.

8. The broadcast signal interface unit of claim 7, wherein the receiver of the first broadcast signal type is coupled to the broadcast signal converter via a wired connection.

9. The broadcast signal interface unit of claim 7, wherein the broadcast signal interface unit further comprises the receiver of the first broadcast signal type.

10. The broadcast signal interface unit of claim 9, wherein the broadcast signal interface unit is portable.

11. The broadcast converter of claim 1, wherein the first broadcast signal type is a Satellite Digital Audio Radio Service (SDARS).

12. The broadcast converter of claim 11, wherein the ancillary data is Program Associated Data (PAD).

13. The broadcast converter of claim 11, wherein the second broadcast signal type is Frequency Modulation (FM) with Radio Data Service (RDS).

14. The broadcast signal interface unit of claim 1, wherein the broadcast channel of the second broadcast signal type is provided either wirelessly or via a wired connection to the one or more broadcast receivers of the second broadcast signal type.

15. The broadcast signal interface unit of claim 1, wherein the program content and ancillary data of the first broadcast signal type are program content and ancillary data from a currently or newly selected channel of the first broadcast signal type, wherein the ancillary data is associated with the program content.

16. The broadcast signal interface unit of claim 1, wherein the program content and ancillary data of the first broadcast signal type are program content from a currently or newly selected channel of the first broadcast signal type and the and ancillary data from a currently or newly browsed channel of the first broadcast signal type, wherein the ancillary data is not associated with the program content.

17. The broadcast signal interface unit of claim 1, wherein the converter comprises:
a controller for sending one or more commands to a receiver of the first broadcast signal type, wherein the one or more commands comprises a command to change a currently selected broadcast channel of the first broadcast signal type or a command to change a currently browsed broadcast channel of the first broadcast signal type.

18. The broadcast signal interface unit of claim 1, wherein the one or more broadcast receivers reproduce the program content and the ancillary data separately.

19. A method of converting program content and ancillary data of a first broadcast signal type into a broadcast channel of a second broadcast signal type, wherein the broadcast channel of the second broadcast signal type is provided to one or more broadcast receivers of the second broadcast signal type in order to reproduce the program content and the ancillary data, the method comprising the steps of:
generating the broadcast channel of the second broadcast signal type, wherein the generated broadcast channel of the second broadcast signal type comprises the program content and ancillary data of the first broadcast signal type.

20. The method of claim 19, further comprises the step of reformatting the ancillary data according to an ancillary data format of the second broadcast signal type.

21. The method of claim 20, wherein the step of reformatting the ancillary data comprises the step of segmenting the ancillary data such that individual segments are individually and consecutively reproduced by the one or more broadcast receivers of the second broadcast signal type.

22. The method of claim 20, wherein the step of reformatting the ancillary data comprises the step of adding, subtracting or substituting data from the ancillary data.

23. The method of claim 19, wherein the step of generating the broadcast channel of the second broadcast signal type comprises the step of directly converting a broadcast channel of the first broadcast signal type into the broadcast channel of the second broadcast signal type.

24. The method of claim 19, wherein the step of generating the broadcast channel of the second broadcast signal type comprises the step of converting the program content and the ancillary data of the broadcast channel of the first broadcast signal type into the broadcast channel of the second broadcast signal type.

25. The method of claim 24, wherein the step of generating the broadcast channel of the second broadcast signal type is performed by a converter, and wherein the ancillary data of the first broadcast signal type is provided to the converter from a receiver of the first broadcast signal type.

26. The method of claim 25, wherein the ancillary data of the broadcast channel of the first broadcast signal type is provided from the receiver of the first broadcast signal type to the converter via a wired connection.

27. The method of claim 25, wherein the receiver of the first broadcast signal type and the converter are integrally provided within a common housing.

28. The method of claim 27, wherein the receiver of the first broadcast signal type and the converter are integrally provided within a portable device.

29. The method of claim 19, wherein the first broadcast signal type is a Satellite Digital Audio Radio Service (SDARS).

30. The method of claim 29, wherein the ancillary data is Program Associated Data (PAD).

31. The method of claim 29, wherein the second broadcast signal type is Frequency Modulation (FM) with Radio Data Service (RDS), the generating step further comprising the steps of:
powering on a SDARS FM-RDS interface unit and a SDARS universal tuner unit;
requesting and receiving SDARS ancillary data relating to the last channel selected and/or listened to before the SDARS RM-RDS interface unit was powered off;
receiving the corresponding SDARS ancillary data for the requested information and converting it into RDS formatted data;
modulating the RDS formatted data using FM modulation to generate a FM-RDS broadcast signal of a certain channel;
transmitting the FM-RDS broadcast signal to a FM-RDS radio for display;
determining if a user control input is generated to indicate that a user has made at least one of a currently selected or browsed channel change selection; and
obtaining ancillary data corresponding to the channel change selection from the SDARS universal tuner unit if the user has made a new channel change selection and converting it into RDS format for display in RDS format.

32. The method of claim 19, further comprising the step of providing the broadcast channel of the second broadcast signal type either wirelessly or via a wired connection to the one or more broadcast receivers of the second broadcast signal type.

33. The method of claim 19, wherein the program content and ancillary data of the first broadcast signal type are program content and ancillary data from a currently or newly selected channel of the first broadcast signal type, wherein the ancillary data is associated with the program content.

34. The method of claim 19, wherein the program content and ancillary data of the first broadcast signal type are program content from a currently or newly selected channel of the first broadcast signal type and the and ancillary data from a currently or newly browsed channel of the first broadcast signal type, wherein the ancillary data is not associated with the program content.

35. The method of claim 19, further comprising the step of sending one or more commands to a receiver of the first broadcast signal type, wherein the one or more commands comprises a request for ancillary data of the last received broadcast channel or a user command to change the current broadcast channel received by the receiver of the first broadcast signal type.

36. The method of claim 19, wherein the one or more broadcast receivers reproduce the program content and the ancillary data separately.

37. A computer-readable medium having embodied thereon a computer program for the method of converting program content and ancillary data of a first broadcast signal type into a broadcast channel of a second broadcast signal type, wherein the broadcast channel of the second broadcast signal type is provided to one or more broadcast receivers of the second broadcast signal type in order to reproduce the program content and the ancillary data, the method comprising:
generating the broadcast channel of the second broadcast signal type, wherein the generated broadcast channel of the second broadcast signal type comprises the program content and ancillary data of the first broadcast signal type.
